(19) United States
(12) Patent Application Publication
(10) Pub. No.: US 2026/0170806 A1
(43) Pub. Date: Jun. 18, 2026

(54) METHOD FOR ASCERTAINING AN ERROR MEASURE IN THE DETECTION AND/OR CLASSIFICATION OF IMAGE DATA

(71) Applicant: Robert Bosch GmbH, Stuttgart (DE)

(72) Inventors: Dirk Raproeger, Wunstorf (DE); Falko Matern, Erlangen (DE); Jochen Kall, Hildesheim (DE); Paul Robert Herzog, Hildesheim (DE)

(21) Appl. No.: 19/412,135

(22) Filed: Dec. 8, 2025

(30) Foreign Application Priority Data
Dec. 11, 2024 (DE) 10 2024 211 799.4

(51) Int. Cl. G06V 10/764; G06N 3/0475; G06T 5/70

(52) U.S. Cl. CPC G06V 10/764; G06N 3/0475; G06T 5/70; G06T 2207/20182

(57) ABSTRACT

A method for ascertaining an error measure in the detection and/or classification of image data in a predetermined domain. The method includes: providing image data for the predetermined domain; applying an image perturbation to the provided image data to generate perturbed image data; providing the perturbed image data to a pre-trained perturbation removal diffusion model; removing the perturbations from the perturbed image data by the pre-trained perturbation removal diffusion model in order to generate perturbation-removed image data; providing the perturbation-removed image data to a detection and/or classification model for detecting the domain in the perturbation-removed image data and/or for classifying the perturbation-removed image data into a class of the domain; and ascertaining an error measure of the detection and/or the classification using the detected domain or the classified class of the domain and the image perturbations.

### FIELD

The present disclosure relates to a method and device for ascertaining an error measure in the detection and/or in the classification of image data in a predetermined domain.

### BACKGROUND INFORMATION

In order to evaluate a new camera with regard to a perception task (e.g., traffic sign recognition), many hours of video or imagery must be captured and annotated, which means high costs and many man-hours in practice.

Due to data-driven perception algorithms, the information content in the images with respect to a dedicated AI task is currently not objectively evaluable since the required signal in the images does not necessarily align with human perception. This means that, according to the current state of the art, it is generally not possible to make an objective statement as to whether the parameters of a camera are sufficient for a particular perception task or even which parameter values can be considered a minimum requirement.

Therefore, it is still common practice to collect large amounts of imagery with a previously defined target camera in a certain initial configuration, then to train an algorithm on these data, and subsequently to evaluate its performance. If there is a change to the hardware or configuration, this process must be iteratively repeated until either a satisfactory hardware setup has been found or the available budget has been used up.

Algorithms that optimize the camera parameters for a perception task end-to-end are currently still academic in nature and are limited to specific parts, such as the software-side ISP (image signal processing) of the camera or optical components.

In machine learning, diffusion models, also known as diffusion-based probability models, are a class of generative models. A diffusion model consists of three main components: the forward process, the reverse process, and the sampling method. The goal of diffusion models is to learn a diffusion process that generates, for a given dataset, a probability distribution from which new elements can subsequently be sampled. They learn the latent structure of a dataset by modeling how data points diffuse through their latent space.

In the case of computer vision on images, diffusion models can be applied to a variety of tasks including image noise suppression, inpainting, super-resolution, and image generation. This typically includes training a neural network to sequentially denoise images superimposed with Gaussian noise, for example. The model is trained to reverse the process of adding noise to an image. After the training on an image data volume, it can be used to generate images by starting with an image of random noise, which the network iteratively denoises. A variety of different approaches has already been developed for this purpose.

It is an object of the present disclosure to provide a further improved method and/or an improved device.

The object may be achieved by a method according to certain features of the present disclosure. The object may be achieved by a device according to certain features of the present disclosure.

According to a first aspect of the present disclosure, a method for ascertaining an error measure in the detection and/or in the classification of image data in a predetermined domain is provided. According to an example embodiment, the method comprises the steps of:
providing image data for the predetermined domain;
applying an image perturbation to the provided image data in order to generate perturbed image data;
providing the perturbed image data, preferably with associated perturbation parameters, to a pre-trained perturbation removal diffusion model, which is preferably pre-trained on a set of images with random combinations of perturbations;
removing the perturbations from the perturbed image data by the pre-trained perturbation removal diffusion model in order to generate perturbation-removed image data;
providing the perturbation-removed image data to a detection and/or classification model for detecting the domain in the perturbation-removed image data and/or for classifying the perturbation-removed image data into a class of the domain; and
ascertaining an error measure of the detection and/or the classification using the detected domain or the classified class of the domain and the image perturbations.

It is understood that the steps according to the present disclosure and further optional steps do not necessarily have to be carried out in the order shown, but can also be carried out in a different order. Further intermediate steps may also be provided. The individual steps may also comprise one or more substeps without departing from the scope of the method according to the present disclosure.

According to a second aspect of the present disclosure, a device for ascertaining an error measure in the detection and/or in the classification of image data in a predetermined domain is provided. According to an example embodiment, the device comprises an evaluation and computing unit that is designed to carry out the following steps:
providing image data for the predetermined domain;
applying an image perturbation to the provided image data in order to generate perturbed image data;
providing the perturbed image data, preferably with associated perturbation parameters, to a pre-trained perturbation removal diffusion model, which is preferably pre-trained on a set of images with random combinations of perturbations;
removing the perturbations from the perturbed image data by the pre-trained perturbation removal diffusion model in order to generate perturbation-removed image data;
providing the perturbation-removed image data to a detection and/or classification model for detecting the domain in the perturbation-removed image data and/or for classifying the perturbation-removed image data into a class of the domain; and
ascertaining an error measure of the detection and/or the classification using the detected domain or the classified class of the domain and the image perturbations.

The present document describes a method that allows the sensitivity of a specific AI perception to certain camera parameters to be systematically evaluated without having to retrain and test the specific AI perception algorithm on large image data volumes. The present method is thus both camera-agnostic and, to a certain extent, AI-task-agnostic.

The present method allows the analysis of the required camera parameters and ISP parameters to be performed by a specific AI detector/classifier (down-stream task) independently of the machine perception (perception task). That is to say, limits for the signal to be supplied by the sensor system (e.g., a required minimum signal-to-noise ratio, a required minimum resolution, etc.) are to be found in order to make a defined perception task possible in principle. This allows, for example, an application-specific estimation for the required camera hardware to be performed even before installation and data recording.

In the present case, a generative diffusion foundation model that has been pre-trained on a large amount of images is used for this purpose. For example, if a noisy image with a known noise level is given, the generative diffusion foundation model can generate a noise-free image via a reverse stochastic diffusion process. In this case, the diffusion model has essentially learned to reconstruct the original noise-free image. However, the lower the signal-to-noise ratio, the more new content is “hallucinated” by the diffusion model, ultimately resulting in completely random images from the entire set of plausible (learned) distributions when pure noise is given. If the diffusion foundation model is able, for example, to reconstruct a noise-free image, which leads to a successful solution of the perception task on average, the signal (i.e., “features”) required for the task is still contained in the image.

The method(s), device(s), and system(s) of the present disclosure may be used, for example, in the predevelopment/optimization of camera sensors, the requirements analysis and the concept development.

Since the foundation diffusion model can be trained on a variety of images, it can generalize to any image and therefore be decoupled from the AI perception task. In other words, if the diffusion model cannot reconstruct the original image semantically from a noisy image, the required signal in the image for detection is lost, meaning that the diffusion model only hallucinates content and thus changes the semantics with respect to the perception task. Since the output of the diffusion is a “clean” image without the perturbations to be investigated, the perception task, e.g., for an AI detector/classifier, is greatly simplified and any (camera-independent) algorithm can be used. If a task-specific perception algorithm is not able to recognize, for example, the correct class of an image, it is assumed that, for example, the signal-to-noise ratio is in principle too low for the perception task.

This “denoising” diffusion process or “perturbation removal” diffusion process is in this case not limited to normally distributed noise. The diffusion process can be trained on any type of continuously generable image degradations, such as blur, masking, JPEG encoding with different quantization settings, etc. The principle always remains unchanged.

The approach is generally applicable to many perception tasks treated as an AI detection or classification problem. Without loss of generality, the application of the classification of traffic signs is considered here by way of example.

In the present case, for example, camera-related “perturbation parameters” can thereby be divided into categories of image perturbations, such as: noise, blur, resolution, etc.

The statements made for the method apply accordingly to the device. It is understood that any linguistic variations of features formulated according to the method can be reformulated for the device according to standard linguistic practice, without such formulations having to be explicitly listed here.

By using the generalized diffusion model, which is conditioned to certain perturbation parameters, it is possible to train or retrain it on 2D-augmented images. At inference time, when a specific detection/classification task is to be evaluated with regard to its sensitivity to the camera and/or the ISP parameters, the present method is performed. Preferably, task-specific images are selected (e.g., images from the traffic sign training set). These images are preferably augmented with a random combination of the camera-related perturbation parameters. The diffusion model reconstructs (denoises) these input images, given the encoded perturbation parameters. For example, a task-specific perception algorithm then classifies the reconstructed images. Furthermore, error measures are calculated and classification statistics are preferably recorded. Furthermore, an evaluation of the classification statistics with respect to camera parameters may be performed.

Existing real data (of the highest quality possible) or synthetically generated images can serve as image data or as input data.

The perturbation in the perturbed image data is removed by the diffusion model (e.g., denoising, sharpening, etc.). In the present case, an additional conditioning, such as on text or guidance labels as is common with diffusion models with text prompts, is not selected, but only the image processed with the perturbation signals and preferably the encoded perturbation signal variables or perturbation parameters as conditioning.

According to an example embodiment, preferably, the perturbation is removed in multiple iterations. The images whose perturbations have been removed in multiple iterations are subsequently preferably fed to the detection and/or classification model, which predicts the domain and/or the class of the image within the domain.

This process is preferably repeated many times in order to ascertain the expected value of the detection rate over all perturbation parameters.

The recognition statistics may be recorded, for example, in a tensor having a dimension equal to the number of perturbation parameters tested (e.g., 3 for noise, blur, resolution). The tensor may then preferably be analyzed in order to visualize, for example, 2D image statistics, in order thus to analyze, for example, a “sweet spot” in the detection task, i.e., the order of magnitude of the perturbation at which recognition drops significantly, or in order to find the camera/ISP parameters that still make possible a minimum required for the detection/classification task. This last step thus results in a “camera-agnostic” statement as to how strong the individual perturbations or combinations of perturbations may be in the perception task being investigated, before detection/classification is expected to be no longer possible even for a specifically trained algorithm. The result preferably represents an upper limit for perturbation strengths of a camera image at which a detection and/or classification algorithm may still function for the application being investigated.

In a further aspect of the present disclosure, it is provided that the image data comprise real images of the domain, preferably in high-definition (HD) resolution, and/or synthetically generated images for the domain.

Other resolutions are also possible.

In a further aspect of the present disclosure, it is provided that the image perturbation comprises noise and/or blur and/or resolution reduction, wherein the image perturbation is generable by means of an image filter and/or an image sensor model and/or another image processing method.

Random perturbations (e.g., noise, blur, resolution, masking, etc.) are preferably selected and applied to the cleanest possible reference input image of the domain, e.g., a traffic sign. This may be done, for example, by image filters, sensor models, or other image processing methods.

The pre-trained perturbation removal diffusion model, which has been trained on a large amount of images with random combinations of perturbations, receives as input the images with perturbations and the associated parameters encoded for the diffusion model.

In a further aspect of the present disclosure, it is provided that providing the perturbed image data comprises encoding the perturbed image data by means of sinusoidal position embedding, wherein the particular sinusoidal position embedding is provided to the perturbation removal diffusion model as an additional input variable or is added to the particular perturbed image data.

This encoding may occur, e.g., as in the related art, via sinusoidal position embedding, which is given (concatenated) to the neural network as an additional input variable or is added to the image data themselves.

In a further aspect of the present disclosure, it is provided that the perturbations comprise augmented perturbations, and wherein the perturbation removal diffusion model is retrained in order to be conditioned to the augmented perturbations.

For example, the augmented perturbations may be extended. For this purpose, a pre-trained diffusion model can be trained anew or retrained in order to be conditioned to new perturbation signals.

In a further aspect of the present disclosure, it is provided that the image data are furthermore manipulated by geometric operations, in particular perspective or affine distortions, in particular preferably rotation, translation, shearing, and/or contrast variation and/or background variation.

Furthermore, in addition to the continuous perturbation signals, other augmentations may be applied to the reference images prior to the diffusion (e.g., geometric rotation, translation, contrast, background), which are preferably not removed by the diffusion model but should be retained in the output image as much as possible.

In a further aspect of the present disclosure, the reference input images may also be augmented onto a new background image, thus creating a new context for the diffusion model, thereby allowing the output image to be evaluated for AI detection tasks since it must first be found in the entire image by the AI detector.

In a further aspect of the present disclosure, it is proposed that the perturbation removal diffusion model is furthermore provided with a common superclass of the image data in the domain as a text prompt.

For example, the diffusion model can be conditioned to the specific task by the network receiving the desired common superclass of the images as an input, for example, as an additional text prompt. In the case of traffic sign recognition, this would be, for example, the text prompt “Traffic sign” or “Road sign”, but not the desired subclass of the sign. Furthermore, it is possible to train the diffusion model with the detection or classification algorithm as an error function (end-to-end) prior to the application of the proposed system.

In a further aspect of the present disclosure, a control unit is also provided, which is comprised in a vehicle having an autonomous driving function and/or a robotic system and/or an industrial machine, and on which the present method can be carried out in one of its aspects.

In a further aspect of the present disclosure, a computer program comprising program code for carrying out at least parts of the present method in one of its aspects when the computer program is executed on a computer is provided. In other words, a computer program (product) comprising instructions that, when the program is executed by a computer, cause said computer to carry out the method/the steps of the method in one of its aspects is.

In a further aspect of the present disclosure, a computer-readable data carrier comprising program code of a computer program for carrying out at least parts of the present method in one of its aspects when the computer program is executed on a computer is proposed. In other words, the present disclosure relates to a computer-readable (storage) medium comprising instructions that, when executed by a computer, cause said computer to carry out the method/the steps of the method in one of its aspects.

The described embodiments and developments can be combined with one another as desired.

Further possible embodiments, developments, and implementations of the embodiments disclosed herein also include not explicitly mentioned combinations of features of the present disclosure, described above or below with respect to exemplary embodiments.

### BRIEF DESCRIPTION OF THE DRAWINGS

The figures are intended to provide a better understanding of the example embodiments of the present disclosure. They illustrate embodiments and, in connection with the description, serve to explain principles and concepts of the present disclosure.

Other embodiments and many of the mentioned advantages emerge with reference to the figures. The shown elements of the drawings are not necessarily drawn to scale with respect to one another.

FIG. 1 shows a schematic flowchart of an exemplary embodiment of the present method.

### DETAILED DESCRIPTION OF EXAMPLE EMBODIMENTS

In the figures of the drawings, identical reference signs denote identical or functionally identical elements, parts, or components unless stated otherwise.

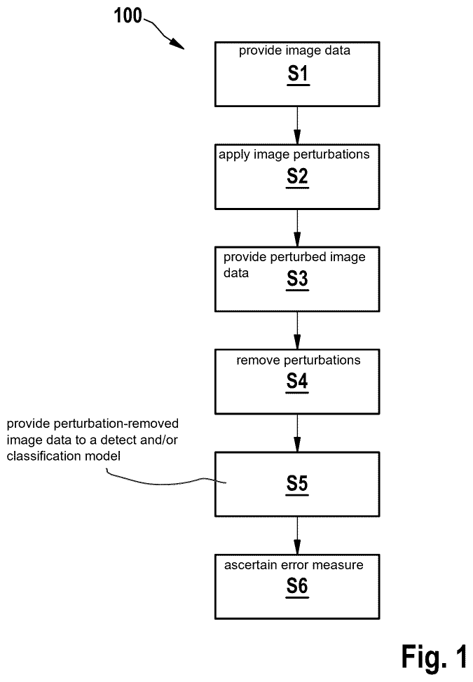

FIG. 1 shows a schematic flowchart of a method for ascertaining an error measure in the detection and/or in the classification of image data in a predetermined domain. For example, the domain may comprise traffic signs from traffic, or a manufacturing environment or a driving environment.

In any embodiment, the method can be carried out at least partially by a device 100, which for this purpose can comprise multiple components not shown in detail, for example one or more provisioning units and/or at least one evaluation and computing unit. It is understood that the provisioning unit may be formed together with the evaluation and computing unit or may be different therefrom. Furthermore, the device 100, which may be a part of a system, may also comprise a storage unit and/or an output unit and/or a display unit and/or an input unit.

The method comprises at least the following steps:

In a step S1, image data for the predetermined domain are provided.

In a step S2, an image perturbation is applied to the provided image data in order to generate perturbed image data.

In a step S3, the perturbed image data, preferably with associated perturbation parameters, are provided to a pre-trained perturbation removal diffusion model, which is preferably pre-trained on a set of images with random combinations of perturbations.

In a step S4, the perturbations are removed from the perturbed image data by the pre-trained perturbation removal diffusion model in order to generate perturbation-removed image data.

In a step S5, the perturbation-removed image data are provided to a detection and/or classification model for detecting the domain in the perturbation-removed image data and/or for classifying the perturbation-removed image data into a class of the domain.

In a step S6, an error measure of the detection and/or the classification is ascertained using the detected domain or the classified class of the domain and the image perturbations.

The method can be explained, for example, in the application of traffic sign recognition. In this case, random signs and distortions (noise, blur, resolution) are selected and are each applied to a “clean” reference input image. The perturbation removal diffusion model, which has been trained on a large amount of images, removes the perturbations from or denoises the images with given perturbation parameters.

Traffic sign recognition is an exemplary application. In general, the method can be applied to a variety of detection tasks, such as pedestrian detection, vehicle detection, etc.

The perturbation-removed or denoised images are then fed to a traffic sign classifier, which predicts the class of the image in the domain of the traffic signs. This process is preferably repeated many times in order to ascertain the expected value, or the error measure, of the detection rate over all distortion parameters or perturbation parameters.

1-10. (canceled)

11. A method for ascertaining an error measure in a detection and/or in a classification of image data in a predetermined domain, the method comprising the following steps:
providing image data for the predetermined domain;
applying an image perturbation to the provided image data to generate perturbed image data;
providing the perturbed image data to a pre-trained perturbation removal diffusion model;
removing perturbations from the perturbed image data by the pre-trained perturbation removal diffusion model to generate perturbation-removed image data;
providing the perturbation-removed image data to a detection and/or classification model for detecting a domain in the perturbation-removed image data and/or for classifying the perturbation-removed image data into a class of the predetermined domain; and
ascertaining the error measure of the detection and/or the classification using: (i) the detected domain or the classified class of the predetermined domain, and (ii) the image perturbations.

12. The method according to claim 11, wherein the perturbed image data are provided with associated perturbation parameters to the pre-trained perturbation removal diffusion model.

13. The method according to claim 11, wherein the pre-trained perturbation removal diffusion model is pre-trained on a set of images with random combinations of perturbations

14. The method according to claim 11, wherein the image data include real images of the predetermined domain, and/or synthetically generated images for the predetermined domain.

15. The method according to claim 11 wherein the image perturbation includes noise and/or blur and/or resolution reduction, and wherein the image perturbation is generable using an image filter and/or an image sensor model and/or an image processing method.

16. The method according to claim 11, wherein the providing of the perturbed image data includes encoding the perturbed image data using sinusoidal position embedding, wherein the sinusoidal position embedding is provided to the perturbation removal diffusion model as an additional input variable or is added to the particular perturbed image data.

17. The method according to claim 11, wherein the perturbations include augmented perturbations, and wherein the perturbation removal diffusion model is retrained to be conditioned to the augmented perturbations.

18. The method according to claim 11, wherein the image data are manipulated by geometric operations, including perspective or affine distortions.

19. The method according to claim 11, wherein the image data are manipulated by rotation and/or translation and/or shearing and/or contrast variation and/or background variation.

20. The method according to claim 11, wherein the perturbation removal diffusion model is furthermore provided with a common superclass of the image data in the predetermined domain as a text prompt.

21. A non-transitory computer-readable data carrier on which is stored program code of a computer program for ascertaining an error measure in a detection and/or in a classification of image data in a predetermined domain, the computer program, when executed by a computer, causing the computer to perform the following steps:
providing image data for the predetermined domain;
applying an image perturbation to the provided image data to generate perturbed image data;
providing the perturbed image data to a pre-trained perturbation removal diffusion model;
removing perturbations from the perturbed image data by the pre-trained perturbation removal diffusion model to generate perturbation-removed image data;
providing the perturbation-removed image data to a detection and/or classification model for detecting a domain in the perturbation-removed image data and/or for classifying the perturbation-removed image data into a class of the predetermined domain; and
ascertaining the error measure of the detection and/or the classification using: (i) the detected domain or the classified class of the predetermined domain, and (ii) the image perturbations.

22. A device for ascertaining an error measure in a detection and/or in a classification of image data in a predetermined domain, the device comprising:
an evaluation and computing unit configured to carry out the following steps including:
providing image data for the predetermined domain;
applying an image perturbation to the provided image data to generate perturbed image data;
providing the perturbed image data to a pre-trained perturbation removal diffusion model;
removing perturbations from the perturbed image data by the pre-trained perturbation removal diffusion model to generate perturbation-removed image data;
providing the perturbation-removed image data to a detection and/or classification model for detecting a domain in the perturbation-removed image data and/or for classifying the perturbation-removed image data into a class of the predetermined domain; and
ascertaining an error measure of the detection and/or the classification using: (i) the detected domain or the classified class of the predetermined domain, and (ii) the image perturbations.
